(19) United States
(12) Patent Application Publication
(10) Pub. No.: US 2012/0100383 A1
(43) Pub. Date: Apr. 26, 2012

(54) Metallized Polypropylene Film and a Process of Making the Same

(76) Inventors: Kwangjin Song, Pittsford, NY (US); Christophe Quillaume, Namur (BE)

(21) Appl. No.: 13/320,669

(22) PCT Filed: Apr. 27, 2010
(86) PCT No.: PCT/US10/32533

§ 371 Date: Jan. 16, 2012

Related U.S. Application Data
(60) Provisional application No. 61/218,710, filed on Jun. 19, 2009.

(51) Int. Cl. B32B 15/08; B05D 3/02; B05D 7/04; B05D 3/10

(52) U.S. Cl. 428/461; 427/537; 427/316

(57) ABSTRACT

This disclosure relates to a multilayer film and a process making such a film. The multilayer film of this disclosure includes (a) a metallizable skin layer having at least one of a grafted isotactic polypropylene, a grafted minirandom copolymer of isotactic polypropylene, a grafted propylene-based elastomer, or any combinations thereof; and (b) a metal layer deposited on the metallizable skin layer, wherein the isotacticity of said isotactic polypropylene is 85% or greater; the ethylene concentration of said minirandom copolymer is 1.0 wt. % or lower; the propylene concentration of said propylene-based elastomer is 89 wt. % or greater; and, wherein the graft monomer includes at least one of ethylenically unsaturated carboxylic acids, ethylenically unsaturated carboxylic acid derivatives and any combination thereof.

### CROSS-REFERENCE TO RELATED APPLICATIONS

This application claims priority from U.S. Provisional Application Ser. No. 61/218,710, filed Jun. 19, 2009, the contents of which are incorporated by reference in their entirety.

### FIELD OF THE INVENTION

This disclosure relates to a metallized multilayer polypropylene film containing a metallizable skin layer deposited thereon a metal layer; and a process of manufacturing such a film. The metallizable skin layer comprises polar modified propylene-based polymers to improve metal adhesion, barrier, crazing resistance, and barrier retention properties of the metallized film.

### BACKGROUND OF THE INVENTION

Metallized multilayer polyolefinic films have been widely used for packaging perishable food or non-food products, owing in part to their good mechanical and optical properties. In order to ensure proper preservation of food products packaged in such polymeric films, it is required to provide packaging films with superior barriers against transmission of air, moisture, flavors, and the like. Polyolefinic packaging films are often metallized to improve gas and moisture barriers.

Surfaces of the polyolefin film are non-polar with a low energy of about 30 dyne/cm and hence lack strong adhesion to polar substrates or metals. This insufficient adhesion is explained due primarily to a high interfacial tension at the boundary of two dissimilar materials, which hinders the formation of strong intermolecular interactions. To improve adhesive properties, the polyolefin film is thus often discharge treated with plasma or co-extruded to dispose a polar functional layer.

Treated surface promotes to an extent adhesion of the polyolefin film to polar substrates. However, the metal layer deposited thereon tends to be picked off during manufacturing or to craze during converting because of the insufficient metal adhesion undergoing external heat and stress. These defects, once they have occurred, substantially degrade appearance and barrier of the metallized film, thereby damaging content of the final package. A number of skills and technologies are thus proposed in the prior art, to improve the adhesive and barrier properties of metallized polyolefin films.

U.S. Pat. No. 5,153,074 discloses a co-extruded metallizable skin layer of ethylene vinyl alcohol copolymer (EVOH). U.S. Pat. No. 5,192,620 discloses a metallizable skin layer made of a blend of EVOH and an ethylene-acrylic acid copolymer. U.S. Pat. No. 5,591,520 discloses a metallizable skin layer of an amorphous polyamide or a blend of an amorphous polyamide and a semicrystalline polyamide. U.S. Pat. No. 6,472,081 discloses a metallizable skin layer of EVOH, poly(vinyl alcohol) (PVOH) and polyester. U.S. Patent Application No. 2007/0141372 discloses a skin layer of a blend of EVOH and amorphous nylon or nylon-containing ionomers.

The metallizable polar skins disclosed above provide in general sufficient polarity for improved metal adhesion and gas barrier. However, the EVOH or nylon based skin has a low barrier to moisture and oxygen at high humidity conditions. Furthermore, the EVOH or nylon based skin may easily degrade during co-extrusion and requires a tie layer disposed intermediate the skin and the polypropylene core layer, thereby lowering film productivity.

U.S. Pat. No. 6,420,041 discloses a metallizable skin layer comprising a compound having the formula of R—X, where R is an aliphatic hydrocarbyl group consisting of 20 to 200 carbon atoms and X is a polar group, such as —COOH or —CH₂OH. U.S. Pat. No. 6,503,635 discloses a metallizable skin layer comprising a blend of syndiotactic polypropylene homopolymer (sPP) and butylene-propylene copolymer or a graft copolymer of propylene and maleic anhydride. U.S. Pat. No. 6,703,134 discloses a metallizable skin layer comprising a graft copolymer of syndiotactic polypropylene homopolymer (sPP) and an ethylenically unsaturated monomer.

U.S. Patent Application No. 2008/0286586 discloses a metallizable composition made from a blend of propylene copolymers and a modifier selected from maleic anhydride grafted metallocene very low or linear low density polyethylene. Very low or low density polyethylene and polypropylene copolymers have low crystallinity and low Tₘ in character, thus producing substantial barrier degradation during the converting process, as described in U.S. Pat. No. 6,190,760.

A need exists for a multilayer polyolefin film that has enhanced productivity, high barrier, high resistance to deformation of the metal layer deposited thereon and that is capable of producing improved adhesion to polar substrates. It is therefore the purpose of this invention to provide a multilayer polypropylene film having exceptional adhesive property and hence high barriers with little or no barrier degradation after the converting process.

### DESCRIPTION OF FIGURES

FIG. 1 shows the normalized OTR as a function of % stretch for some selected Examples and Comparative Examples of the extrusion laminated metallized films.

### SUMMARY OF THE INVENTION

This disclosure relates to a multilayer film comprising (a) a metallizable skin layer having a polymer grafted with a graft monomer, said grafted polymer comprises at least one of a grafted isotactic polypropylene, a grafted minirandom copolymer of isotactic polypropylene, a grafted propylene-based elastomer, or any combinations thereof; and (b) a metal layer deposited on the metallizable skin layer, wherein the isotacticity of said isotactic polypropylene is 85% or greater; the ethylene concentration of said minirandom copolymer is 1.0 wt. % or lower; the propylene concentration of said propylene-based elastomer is 89 wt. % or greater; and, wherein said graft monomer comprises at least one of ethylenically unsaturated carboxylic acids, ethylenically unsaturated carboxylic acid derivatives and any combination thereof. This disclosure also relates to a process of making such a film.

### DETAIL DESCRIPTION OF THE INVENTION

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the disclosure will refer to any one or more of the appended claims, including their equivalents, and elements or limitations that are equivalent to those that are recited. Any reference to the “invention” may refer to one or more, but not necessarily all, of the inventions defined by the claims.

As used herein, the term “monomer” is a small molecule that may become chemically bonded to other monomers to form a polymer. Examples of monomers include olefinic monomers, such as, ethylene, propylene, butylenes, 1-hexene, styrene, and 1-octene.

As used herein, the term “polymer” refers to the product of a polymerization reaction, and is inclusive of homopolymers, copolymers, terpolymers, etc.

As used herein, unless specified otherwise, the term “copolymer(s)” refers to polymers formed by the polymerization of at least two different monomers. For example, the term “copolymer” includes the copolymerization reaction product of propylene and an alpha-olefin (α-olefin), such as ethylene. However, the term “copolymer” is also inclusive of, for example, the copolymerization of a mixture of more than two monomers, such as, ethylene-propylene-butene.

As used herein, weight percent (“wt. %”), unless noted otherwise, means a percent by weight of a particular component based on the total weight of the mixture containing the component. For example, if a mixture or blend contains three grams of compound A and one gram of compound B, then the compound A comprises 75 wt. % of the mixture and the compound B comprises 25 wt. %. As used herein, parts per million (ppm), unless noted otherwise, means parts per million by weight.

Without being bound by any theory or belief herein, the following theory is offered as a means of better describing the present inventive concepts. It is theorized that this disclosure results in raised concentration of desirable polar groups at the surface of the metallizable skin layer by incorporating a grafted isotactic polypropylene polymer or a blend of grafted and ungrafted isotactic polypropylene polymers. For the purposes of this theory, the grafted isotactic polypropylene polymer incorporates polar groups.

The grafted isotactic polypropylene polymer is grafted with a graft monomer. The amount of graft monomer included in the metallizable skin layer should be an amount sufficient to promote metal adhesion to the polypropylene layer. For example, this amount may be 0.01 to 5 wt. % of graft monomer based on the weight of the metallizable skin layer.

The blend of the metallizable skin layer(s) also comprises a polypropylene homopolymer, preferably an isotactic polypropylene homopolymer.

The metallizable skin layer(s) may also comprise other polymers. Suitable polymers include an olefinic homopolymer, such as polypropylene or polyethylene. Other suitable polymers include a copolymer of two or more olefins or a blend of any number of the foregoing olefin polymers, preferably a minirandom copolymer of isotactic polypropylene, propylene-based elastomer, or any combinations thereof. Particular skin layers comprise a linear ethylene homopolymer having a density of about 0.96 g/cm³, and a propylene-butylene copolymer in which the butylene content is about 1 to about 20 wt. %. Although polar polymers, such as polyamides and polyesters are not excluded, they are expected to benefit minimally from this disclosure.

The multilayer film of this disclosure may further comprise at least one of a core layer, a first tie layer, a second tie layer, and a sealant layer.

The core layer may contain other additives such as inorganic fillers, pigments, antioxidants, acid scavengers, ultraviolet absorbers, processing aids such as zinc stearate, extrusion aids, slip additives, permeability modifiers, antistatic additives, cavitating agents such as calcium carbonate and β-nucleating agents. These additives may be introduced into the core layer in the form of master batch in a polyolefin, typically in low density polyethylene (LDPE). LDPE may be used to improve melt strength of linear polymers and improve bubble stability when the film is produced on a blown line.

In some embodiments, the core layer of this disclosure consists essentially polyolefin, e.g., polypropylene, optionally one or more additives, such as cavitating agent. In other embodiments, the core layer of this disclosure is essentially free of polylactic acid (PLA). In yet other embodiments, the core layer of this disclosure comprises less than 10 wt. %, preferably less than 1 wt. %, even more preferably less than 0.5 wt. %, polylactic acid.

The core layer comprises a thermoplastic polymer which has properties suitable for extrusion or coextrusion. The extruded or coextruded sheet may be biaxially oriented in the machine and transverse directions under elevated temperatures so as to form a multilayer film. Although the preferred thermoplastic polymer of the core layer is polypropylene homopolymer, more preferably isotactic polypropylene homopolymer having isotacticity 90% or greater, other polymers, especially polyolefin homopolymers or copolymers, may be used. These polymers include homopolymers and copolymers made from one or more 2- to 8-carbon olefinic monomers, such as ethylene or 1-butene. Preferred copolymer is a minirandom copolymer of isotactic polypropylene having ethylene content 1% or lower.

In one embodiment, to improve the barrier and optical properties of the film, the core layer comprises at least one hydrocarbon resin disclosed in U.S. Pat. No. 7,314,901, the entirety of which is incorporated by reference, in the amount ranging from about 2 to about 50 wt. %, preferably about 3 to about 25 wt. %, based on the total weight of the layer. Examples of the hydrocarbon resin include, but not limited to, aliphatic hydrocarbon resins, aliphatic aromatic hydrocarbon resins, hydrogenated aliphatic hydrocarbon resins, hydrogenated aliphatic aromatic hydrocarbon resins, cycloaliphatic hydrocarbon resins, hydrogenated cycloaliphatic hydrocarbon resins, cycloaliphatic aromatic hydrocarbon resins, hydrogenated aromatic hydrocarbon resins, polyterpene resins, terpene-phenol resins, rosins and rosin esters, hydrogenated rosins and rosin esters, and mixtures of two or more thereof.

The skin layer on the opposite side of the core layer from the metallizable skin layer may be a heat sealable layer, especially comprising heat sealable polyolefinic copolymers, terpolymers, or blends thereof. The copolymers include block copolymers, for example, of ethylene and propylene, and random copolymers, for example, of ethylene and propylene. Terpolymers are exemplified by ethylene-propylene-butene terpolymers. Also, heat sealable blends can be utilized in providing this layer. Along with the copolymer or terpolymer there can be incorporated polypropylene homopolymer or other material which does not impair the heat sealability of this layer.

The skin layer on the opposite side of the core layer from the metallizable layer may comprise a polypropylene homopolymer, such as highly crystalline polypropylene (HCPP), which may help to improve release properties of the film. HCPP polypropylene polymers include those having a decalin soluble content of less than about 5% by weight, meso pentads equal to or greater than about 95% (¹³C NMR spectroscopy), and a melt flow rate of about 1.5 to about 10 g/10 min as measured according to the standard ASTM D1238 test.

The multilayer film may have one or more additional layers, such as a tie layer, in addition to the core and skin layers. It is also possible to have two metallizable skins if vapor deposition on both sides of the film is desired or a high energy surface is desired for printing, coating, or other applications.

Sometimes it is useful to enhance or provide the film with certain properties by use of appropriate film additives. Such additives are used in effective amounts, which vary depending upon the property required, and may be selected from the group consisting of: antistatic, antiblock, slip, or antioxidant additives. These additives may be added to one or more layers of the film according to this disclosure.

Either of the skin layers of the film, preferably the un-metallized or sealable layer, can optionally contain a small amount of antiblock particles, such as clays, talc, glass, and others. One antiblock agent can be used alone, or different sizes and shapes can be blended to optimize machinability. The major proportion of the particles, for example, more than half, may be of such a size that a significant portion of their surface area will extend beyond the exposed surface of such skin layer. Suitable antiblocks include, but are not limited to, fully cross-linked non-meltable polymethyl methacrylate (PMMA) particles, such as EPOSTAR™MA-1002, or silica (SiO₂) particles, such as SYLOBLOC™ 44 from W. R. Grace, or fully cross-linked or non-meltable polysiloxane micro-spheres, such as TOSPEARL T120A™, from Toshiba Silicone Company, Ltd. Partially cross-linked polysiloxane particles, which release non-cross-linked liquid silicone under stress, as described in U.S. Pat. No. 5,840,419, can also be used. The solid antiblock agent may be incorporated into the layer in an amount ranging from about 0.1 to about 0.5% by weight, preferably from about 0.15 to about 0.30% by weight, based on the entire weight of the layer.

Useful antistatic additives which can be used in amounts ranging from about 0.05 to about 3 wt. %, based upon the weight of the layer, include alkali metal sulfonates, polyether-modified polydiorganosiloxanes, polyalkylphenylsiloxanes and tertiary amines. The antistatic agent may be glycerol monostearate (GMS) or a blend of GMS and tertiary amine.

Slip additives include higher aliphatic acid amides, higher aliphatic acid esters, waxes and metal soaps, which can be used in amounts ranging from about 0.1 to about 2 wt. % based on the total weight of the layer. A specific example of a fatty amide slip additive is erucamide. Optionally, one or more layers are compounded with a wax for lubricity. Amounts of wax range from about 1 to about 15 wt. % based on the total weight of the layer. Waxes and slip additives tend to migrate towards the surface of the film. If, prior to metallization, they migrate to the metallizable surface, or they migrate to the opposite surface and are transferred to the metallizable surface by contact, metal adhesion may be impaired. Therefore, it may be necessary to include such additives in a core or tie layer, and not directly in either of the skin layers, to delay their migration. It may further be necessary to minimize the delay between film manufacture and metallization.

Antioxidants, such as phenolic antioxidants, may be used in amounts ranging from about 0.1 to about 2 wt. %, based on the total weight of the layer. An example of an antioxidant is commercially available under the trademark IRGANOX 1010.

The multilayer film may also comprise coatings, such as an adhesive layer (e.g., a water-based urethane coating), and/or a cold seal layer (e.g., Technical Coatings 30061A, which is a pattern applied coating comprising polyisoprene and ethylene-vinyl acetate copolymer), as is well known in the art.

A grafted polypropylene homopolymer is a branched polymer containing a polymer chain (referred to the backbone polymer) derived from propylene monomer to which is attached one or more side chains of graft monomers. Preferred graft monomers do not polymerize each other that produces a graft branch of their homopolymer chains.

The polypropylene polymers used as a backbone polymer of graft reaction are one selected from isotactic polypropylene homopolymers (iPP), mini-random copolymers of isotactic polypropylene (mr-iPP), propylene-based elastomers, or any combinations thereof. The backbone polypropylene polymers can be prepared by metallocene catalysts, Ziegler-Natta catalysts, or other suitable catalysts. Preferably, iPP has an isotacticity (% Iso) 85% or greater; a crystalline melting temperature (Tₘ) 150° C. or greater in DSC; and, a melt flow rate (MFR) 20 g/min or lower. Preferred mr-iPP has ethylene content 1.0% or lower, Tₘ 150° C. or greater in DSC, and MFR 20 g/min or lower. Preferred propylene-based elastomers are ethylene propylene elastomers having propylene content 89% or greater, Tₘ 75° C. or greater in DSC, and MFR 20 g/min or lower.

In one embodiment, the backbone polypropylene polymer is iPP or mr-iPP. The backbone polypropylene polymers can be prepared by metallocene catalysts, Ziegler-Natta catalysts, or other suitable catalysts.

In certain embodiment, the backbone polypropylene polymer is ethylene propylene elastomer, which is prepared by metallocene catalysts, as disclosed in WO 2007/114811, the entirety of which is enclosed by reference.

In some embodiments, the metallizable skin layer comprises grafted propylene-based elastomers. The amount of the grafted propylene-based elastomers in the metallizable skin layer is in a range from about 1 to about 30 wt. %, preferably about 3 to 20 wt. %, based on the total weight of the metallizable skin layer. Preferred propylene-based elastomers are ethylene propylene (EP) elastomers having propylene concentration 89 wt. % or higher and Tₘ 75° C. or greater. Commercially available such EP elastomers include VISTAMAXX™ by ExxonMobil Chemical, VERSIFY™ by Dow Chemical, NOTIO™ by Mitsui Chemical, and etc.

The graft monomer is at least one ethylenically unsaturated carboxylic acid or acid derivative, such as an acid anhydride, ester, salt, amide, imide, or the like. Such monomers include acrylic acid, methacrylic acid, maleic acid, fumaric acid, itaconic acid, citraconic acid, mesaconic acid, maleic anhydride, 4-methyl cyclohex-4-ene-1,2-dicarboxylic acid anhydride, bicyclo(2.2.2)oct-5-ene-2,3-dicarboxylic acid anhydride, 1,2,3,4,5,8,9,10-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, maleopimaric acid, tetrahydrophtalic anhydride, norborn-5-ene-2,3-dicarboxylic acid anhydride, nadic anhydride, methyl nadic anhydride, himic anhydride, methyl himic anhydride, and x-methylbicyclo(2.2.1)hept-5-ene-2,3-dicarboxylic acid anhydride (XMNA).

Preferably, the graft monomer is one of maleic anhydride (MAH), methyl methacrylate, acrylic acid, methacrylic acid, hydroxyethyl methacrylate, hydroxypropyl methacrylate, glycidyl methacrylate (GMA) or any combinations thereof. MAH and GMA are the most preferred graft monomers.

### Process of Making

The film may be formed by coextruding the thermoplastic polymer-containing core layer together with the at least one skin layer and optional additional layers through a flat sheet extrusion die at a temperature ranging from between about 200 to about 275° C., casting the sheet onto a cooling drum and quenching the sheet in a water bath. The sheet may then be stretched about 4 to about 6 times in the machine direction (MD) between rolls, and then stretched about 6 to about 10 times in the transverse direction (TD) in a tenter. Alternatively, the MD and TD stretches may occur more or less simultaneously by means of suitable machinery, such as described in U.S. Pat. No. 4,853,602. The film may then be wound onto a reel. Optionally, one of the external surfaces, i.e., the surface of the functional skin layer, is coated or flame or corona treated before winding to render the film receptive to metallization, coatings, printing inks, and/or lamination. In addition, the production process may also include coating an adhesive and/or cold seal layer on one or both surfaces of the multilayer polymeric film. Preferably, the metallizable skin layer of the film is further treated with plasma prior to the metallization.

The core layer may represent about 70 to about 90 percent of the thickness of the total multilayer polymeric film. The skin layers are usually coextensively applied to each major surface of the core layer, typically by coextrusion, as noted above. However, skin layers arrived at by coextrusion may not, ultimately, be the outermost layers.

Metal layers are known in the art, and can be deposited using any known method, for instance, vacuum deposition, electroplating, sputtering, etc. Preferably, the metal layer is one of vacuum deposited aluminum, copper, silver, chromium, gold, and mixtures thereof, with vacuum deposited aluminum being most preferred. A protective acrylic or other polymeric coating may be deposited over the metal layer under vacuum, preferably in the metallization machine, as taught, for example, by U.S. Pat. No. 4,842,893.

A polymeric film may be laminated to the metal layer of the multilayer film to protect the metal from scratching and scuffing during use. Such polymeric film can improve the gauge, stiffness and puncture resistance of the overall film, and can further enhance the barrier properties of the film. The polymeric film using for lamination can be oriented, unoriented, transparent or opaque. Preferably, the polymeric film is polypropylene or polyethylene, most preferably oriented polypropylene (OPP). Such an additional polymeric film can be laminated to the metal layer using any suitable adhesive. A particularly preferred adhesive is a hot melt low density polyethylene, applied in an amount of about 4.54 Kg per ream.

The multilayer films of this disclosure may have a total thickness of, for example, about 10 to about 50 μm. The metallizable skin layer may have a thickness of, for example, about 0.5 to about 4 μm.

The metallized films of this disclosure have OTR 30 cc/m²/day or lower and WVTR 0.3 g/m²/day or lower and a ratio 10 or lower of OTR and WVTR increases before and after 12% stretch of the extrusion laminated metallized film. The metallized films exhibit little or no metal pickoff and little or no crazing in extrusion lamination, the level of both being 10% or lower, according to the procedure described in the following section of Test Procedure.

In some embodiments, this disclosure relates to a method of making a film of this disclosure, the method comprising:
a. extruding a composition comprising the propylene-based graft polymers of this disclosure through a sheet-forming die to form a sheet;
b. cooling the sheet by a chill roll and/or a water bath;
c. orienting the sheet in MD, TD, or MD and TD to form a film;
d. treating at least one surface of the oriented film with corona, flame, plasma, or combination thereof; and
e. metallizing the treated surface of the metallizable skin layer of the oriented film.

In other embodiments, this disclosure relates to a process for manufacturing a multilayer polypropylene film that includes the steps of co-extrusion of the composition polymer melts through a film forming die, casting of the co-extrudates to form a multilayer sheet, biaxial stretching of the sheet, treating of at least one outer surface of the biaxially oriented multilayer film with corona, flame, plasma, or combination thereof; and deposition of metal onto the treated surface of the metallizable skin layer.

### Preparation of Graft Polymers

The graft polymer may be prepared in solution, in a fluidized bed reactor, or by melt grafting. A preferred graft method is melt blending of the backbone polymers, in the substantial absence of a solvent, with a free radical generating catalyst, such as peroxides, in the presence of the graft monomer in a shear-imparting reactor, such as extruders. Co-kneaders and twin screw extruder reactors, such as co-rotating intermeshing or counter-rotating non-intermeshing extruders, are preferred.

The graft polymerization is carried out at a temperature selected to minimize or avoid rapid vaporization and consequent losses of the catalyst and monomer and to have residence times about 6 to 7 times the half life time of the peroxide. The peroxide is usually dissolved at an approximate 10 wt. % concentration in a mineral oil whereas the backbone polymer and the graft monomer are fed neat.

Optionally, the graft polymer may include as a toughener one or more ethylene-based elastomer or polar modified ethylene-based elastomer in the amount ranging from about 5 to 25 wt. %. Examples of such elastomers include ethylene-propylene copolymers (EPM), polar modified EPM, ethylene-butylene copolymers, polar modified ethylene-butylene copolymers, ethylene-octene copolymers, polar modified ethylene-octene copolymers, styrene-butadiene-styrene copolymers (SBS), polar modified SBS, styrene-ethylene-butylene-styrene copolymers (SEBS), polar modified SEBS, and any combinations thereof.

Commercially available propylene-based graft polymers include Admer™ by Mitsui Chemicals, Inc., Exxelor™ by ExxonMobil Chemical Company, Fusabond™ by E.I. du Pont de Nemours and Company, Plexar™ by Equistar Chemicals, LP, Priex™ by Solvay Chemicals, Inc., Orevac™ by Arkema Inc., etc.

### INDUSTRIAL APPLICATION

In some embodiments, the film of this disclosure may be used in flexible packaging and labeling applications.

Films according to the present disclosure may further be treated for its intended use such as by coating, printing, slitting, or other converting methods. Preferred production methods of the inventive film comprise co-extruding, casting and then orienting the cast sheet to form a film.

The present disclosure will be explained in more detail referring to Examples below without intention of restricting the scope of the present disclosure.

### Test Procedures

The properties of the films in the Examples (“Ex”) and Comparative Examples (“Cx”) were measured by the following test methods.

The melt flow rate (“MFR”) was measured according to ASTM D-1238, wherein a 2.16 kg weight at 230° C. with a 1 minute preheat on the sample to provide a steady temperature for the duration of the experiment is used. The melt index (“MI”) was measured according to ASTM D-1238, condition E, at 190° C. and 2.16 kg mass. The measured unit of both MFR and MI was expressed in g/10 min.

Percent Isotacticity (% Iso): The isotacticity of polypropylene sample was measured using the Soxhlet extraction method. Additives were first removed by extracting the sample with n-heptane for 2 hours at 60° C. in a Soxhlet extractor. The sample was then weighed (W₁) after 5 hour drying at 130° C. in vacuum, which was extracted again for 12 hours with boiling n-heptane in the Soxhlet extractor. The extracted sample was thoroughly washed with acetone and then dried for 10 hours at 130° C. in vacuum. The cooled sample was weighed (W₂). The isotacticity of the PP sample was then computed via:

$$Isotacticity ( \% ) = \frac{{W}_{2}}{{W}_{1}} \times 100$$

Crystalline Melting Temperature (Tₘ): Tₘ of the polymer was measured according to ASTD D3418 with Differential Scanning calorimeter (DSC, Perkin Elmer Pyris 1 Thermal Analysis System). Polymer sample of 15 to 20 mg, equilibrated to 25° C., was heated beyond its Tₘ and then cooled to 25° C. at a rate of 10° C./min. The sample was allowed to equilibrate for 3 minutes and then reheated again beyond its Tₘ at a rate of 10° C./min. The melting temperature is defined as the point where, during the second melting of the sample, the peak endothermic heat flow required to maintain the heating rate of 10° C./min is observed.

MAH Content: The maleic anhydride (MAH) content of the graft polymer is measured by Fourier Transform Infrared Spectroscopy (FTIR). A thin polymer film is pressed from 2-3 pellets at about 165° C. When the film is used as such, the maleic anhydride content is reported as before oven. The film is then placed in a vacuum oven at about 105° C. for about 1 hour and placed in the FTIR; the measured maleic anhydride content is reported as after oven. The peak height of the anhydride absorption band at 1790 cm⁻¹ (A₁₇₉₀) and of the acid absorption band (from anhydride hydrolysis in air) at 1712 cm⁻¹ (A₁₇₁₂) was compared with a band at 4324 cm⁻¹ (A₄₃₂₄) serving as a standard. The total percentage of maleic anhydride (% MA) was then calculated by the formula:

% MA=a+k(A₁₇₉₀+A₁₇₁₂)/A₄₃₂₄

where “a” and “k” are respectively constant values 0.078 and 0.127, determined by calibration with internal standards.

Barrier and Barrier Degradation: Oxygen transmission rate (OTR) was measured by using a Mocon Oxtran 2/20 unit in accordance with ASTM D3985 at 23° C. and 0% relative humidity (RH), and moisture vapor transmission rate (WVTR) by using a Mocon Permatran 3/31 unit in accordance with ASTM F1249 at 37.8° C. and 90% RH. For the measurement of barrier degradation property, the film sample of 12 cm wide and 20 cm long was stretched at a speed of 50 cm/min up to 12% with an Instron tensile tester. The film was then released from the holding grips after the force trace dropped to 60%. OTR and WVTR were measured for variously stretched samples.

Optical Density (OD): OD was measured using a Tobias Associates model TBX transmission densitometer and Macbeth Model TD903 and TD932, according to ANSI/NAPM IT2.19. The densitometer is set to zero with no film specimen. A film specimen is placed over the aperture plate of the densitometer with the test surface facing upwards. The probe arm is pressed down and the resulting optical density value is recorded.

Metal Pickoff: Metal pickoff was measured by removing a strip of 1-inch wide 3M 610 Scotch® tape adhered to the metallized surface of a multilayer film. The amount of metal removed was rated qualitatively as follows: scale 1.0 means less than or equal to 5% metal removed, scale 2.0 means more than 5 to less than or equal to 10% metal removed, scale 3.0 means more than 10 to less than or equal to 20% metal removed, scale 4.0 means more than 20 to less than or equal to 50% metal removed, and scale 5.0 means more than 50% metal removed. Scales 1 or 2 are indication of low metal pickoff.

Extrusion Lamination and Crazing Resistance: The metallized layer of the film was extrusion laminated with low density polyethylene (LDPE) at 320° C. to an 18 μm BOPP film substrate. The weight of LDPE melt was 10 lb/rm that hit directly onto the metallized layer unwound from the primary unwind at 10.5 lb tension. The BOPP film substrate was on the secondary unwind. Crazing resistance of the metallized films was measured visually by rating the amount of crazes produced as follows: scale 1.0 means less than or equal to 5% crazes produced, scale 2.0 means more than 5 to less than or equal to 10% crazes produced, scale 3.0 means more than 10 to less than or equal to 20% crazes produced, scale 4.0 means more than 20 to less than or equal to 50% crazes produced, and scale 5.0 means more than 50% crazes produced. Scale 1 or 2 is indication of low metal crazing.

Bond Strength: The bond strength (σ_{BOND}) of the laminated films was measured with a Sintech tensile tester at the 90° angle testing mode, according to ASTM D1876. The film sample was aged at room condition for 60 days. Specimens were 2.54 cm wide and 15.2 cm long. Both surfaces of the laminated film were taped by 2.54 cm wide 3M 610 Scotch® tape to prevent film tear during the peeling test. The bond strength taken by a peak value was then measured by delaminating the aged sample by pulling the tape on the leading edge end.

### EXAMPLES AND COMPARATIVE EXAMPLES

### Polymers Used in Examples and Comparative Examples

Table 1 shows the compositions and properties of polymers used in the Examples and Comparative Examples. PP4612 and PP4052 are isotactic polypropylene (iPP) homopolymers with isotacticity 92% and 95%, respectively. PP4712 is a minirandom copolymer of isotactic polypropylene (mr-iPP) that has 0.5% ethylene and 92% isotacticity. Vistamaxx™ 3980 is a propylene-based elastomer, containing 91% propylene and 9% ethylene (EP Elastomer). These polymers were commercialized by ExxonMobil Chemical Company. Admer® AT1179 and QF550 are grafted iPP, commercialized by Mitsui Chemical Company. SM7-001 is a syndiotactic polypropylene (sPP) homopolymer grafted with 0.3 wt. % maleic anhydride. Orevac™ QE904 and QE905 are respectively an iPP homopolymer and an ethylene propylene random copolymer having about 6% ethylene, both being grafted with 0.3 wt. % glycidyl methacrylate (GMA). These polymers were commercialized by Arkema Incorporation.

### Graft Polymers

Maleated MDEX and REXT were prepared respectively from PP4712, ethylene propylene random copolymer (E-r-P) containing 3% ethylene, and Vistamaxx™ 3980, with a non-intermeshing counter-rotating twin screw extruder (30 cm, L/D=48). A polymer and 0.8 to 1.2 wt. % of Crystalman™ maleic anhydride (MAH) were fed into the extruder at a rate of 7 kg/h through the hopper and 0.3 to 1.0 wt. % of a 10% solution of Luperox™ 101 dissolved in Marcol™ 52 oil through the second barrel. The extruder ran at 160 rpm and the four zone barrel temperatures were respectively 160, 180, 190, 160° C. Prior to polymer recovery, excess and decomposed components of the feedstock were removed by vacuum. Table 1 shows the specifications and properties of polymers used in the Examples.

TABLE 1
Polymers Used in the Examples and Comparative Examples

| | Base PP | | Grafting | | Property | | Commercial |
|---|---|---|---|---|---|---|---|
| Polymer | Composition | % Iso¹ | Monomer | wt. % | Tₘ (° C.) | MFR² | Source |
| PP4612 | iPP | 92 | / | / | 162 | 2.8 | ExxonMobil |
| PP4712 | mr-iPP | 92 | / | / | 162 | 2.8 | Chemical |
| PP4052 | HC-iPP | 95 | / | | 165 | 2.0 | Company |
| Vistamaxx ™ | 9/91% EP | / | / | / | 95 | 2.0 | |
| 3980 | Elastomer³ | | | | | | |
| MDEX1032 | PP4712 | 92 | MAH | 0.20 | 162 | 5.0 | |
| REXT2106 | VMX3980 | / | MAH | 0.57 | 95 | 3.0 | |
| MDEX1033 | 3/97% E-r- | 80 | MAH | 0.30 | 142 | 8.0 | |
| | p⁴ | | | | | | |
| Admer ® | PP4612 | 92 | MAH | 0.17 | 160 | 4.5 | Mitsui |
| AT1179 | | | | | | | Chemical |
| Admer ® | 80/20% | 92 | MAH | 0.15 | 160 | 4.5 | Company |
| QF550 | iPP/EPDM⁵ | | | | | | |
| Orevac ™ | iPP | 93 | GMA⁶ | 0.3 | 160 | 8.0 | Arkema |
| OE904 | | | | | | | Incorporation |
| Orevac ™ | Co-PP | 80 | GMA | 0.3 | 134 | 8.0 | |
| OE905 | | | | | | | |
| SM7-001 | sPP | / | MAH | 0.4 | 127 | 15.0 | |
| Orevac ™ 18732 | Co-PP | 80 | MAH | 0.3 | 134 | 8.0 | |
| XPM7794 | EPB⁷ | / | / | / | 122 | 5.0 | Japan |
| | | | | | | | Polypropylene |
| | | | | | | | Company |

¹% Iso: % Isotacticity,
²MFR: g/10 min,
³Ethylene Propylene Elastomer,
⁴E-r-P: Ethylene Propylene Random Copolymer,
⁵EPDM: Rubber,
⁶GMA: Glycidyl Methacrylate,
⁷Ethylene-Propylene-Butene-1 Terpolymer

### Film Extrusion

All Examples and all Comparative Examples were five layer films prepared by co-extrusion employing five separate extruders having a total output of about 230 Kg/hour. The two components of the metallizable skin layers were pellet blended prior to co-extrusion. The extrudates were quenched using a chill roll and a water bath. The films were subsequently biaxially stretched in the MD using the combination of slow and fast speed roller and in the TD with the tenter frame; and then relaxed in the TD at a preset ratio by the width of the tenter frame rails.

The biaxially stretched films were then treated by flame and/or plasma to surface energy of 35 dyne/cm or greater, and subsequently metallized by vacuum deposition of aluminum to an optical density (OD) about 2.5.

Table 2 shows a representative multilayer film structure used in the Examples and Comparative Examples. The composition of the metallizable skin layer for the Examples and Comparative Examples are listed in Table 3. All the Examples and Comparative Examples had PP4612 for both tie layers, PP4612 for the core layer, and XPM7794 for the sealant skin layer.

TABLE 2
Representative 5 Layer Structure of
Example and Comparative Example Films

| | Composition | | Thickness |
|---|---|---|---|
| Layer | (%) | Polymer Resin | (μm) |
| Metallizable skin layer | 100 | MDEX1032 | 1.0 |
| Tie | 100 | PP4612 | 3.0 |
| Core | 100 | PP4612 | 10.0 |
| Tie | 100 | PP4612 | 3.0 |
| Sealant Skin | 100 | XPM7794 | 1.0 |

### Examples (Ex) 1 to 3

The metallizable skin layer of Examples 1 to 3 was respectively MDEX1032 and its 50 wt. % blends with PP4712 and PP4052. The measured properties of the Example films are shown in Table 3.

### Examples (Ex) 4 to 6

The metallizable skin layers of Examples 4 to 6 were REXT2106 blends with MDEX1032 and PP4712, respectively. The composition of the metallizable skin layers and the measured properties of the Example films are shown in Table 3.

### Examples (Ex) 7 to 10

The metallizable skin layers of Examples 7 to 10 were Admer® AT1179 and its blends with REXT2106, PP4612 and PP4052, respectively. The composition of the metallizable skin layers and the measured properties of the Example films are shown in Table 3.

### Examples (Ex) 11 to 13

The metallizable skin layers of Examples 11 to 13 were respectively Admer QF550, Orevac™ QE904 and a blend of 50/50% Orevac™ QE904/PP4612. The composition of the metallizable skin layers and the measured properties of the Example films are shown in Table 3.

TABLE 3
Metallizable skin layers and Measured Properties
of the Examples and Comparative Examples

| | | | Metallized Film | | | | Crazing Test | |
|---|---|---|---|---|---|---|---|---|
| | Metallizable skin layer | | Pick | OTR | WVTR | σ_{BOND} | | OTR |
| Film | Component-1 | Component-2 | Off | (cc/m²/d) | (g/m²/d) | (g/in) | Rate | (cc/m²/d) |
| Ex 1 | MDEX1032 | / | 1 | 6.25 | 0.05 | 302 | 1 | 33.5 |
| Ex 2 | 50% MDEX1032 | 50% PP4712 | 1 | 9.13 | 0.04 | 285 | 1 | 27.2 |
| Ex 3 | 50% MDEX1032 | 50% PP4052 | 1 | 6.40 | 0.04 | 280 | 1 | 19.4 |
| Ex 4 | 10% REXT2106 | 90% MDEX1032 | 1 | 5.01 | 0.05 | 396 | 1 | 28.4 |
| Ex 5 | 10% REXT2106 | 90% PP4712 | 1 | 9.89 | 0.05 | 357 | 2 | 27.6 |
| Ex 6 | 20% REXT2106 | 80% PP4712 | 1 | 8.89 | 0.06 | 392 | 1 | 31.5 |
| Ex 7 | AT1179 | / | 1 | 7.62 | 0.05 | 287 | 1 | 35.4 |
| Ex 8 | 80% AT1179 | 20% REXT2106 | 1 | 7.30 | 0.06 | 368 | 2 | 31.6 |
| Ex 9 | 50% AT1179 | 50% PP4612 | 1 | 9.87 | 0.07 | 305 | 1 | 28.5 |
| Ex 10 | 50% AT1179 | 50% PP4052 | 1 | 8.02 | 0.04 | 289 | 1 | 18.2 |
| Ex 11 | QF550 | / | 1 | 10.7 | 0.10 | 273 | 2 | 45.3 |
| Ex 12 | OE904 | / | 1 | 9.42 | 0.08 | 256 | 1 | 34.1 |
| Ex 13 | 50% OE904 | 50% PP4612 | 1 | 10.4 | 0.06 | 274 | 1 | 31.2 |
| Cx 1 | PP4612 | / | 4 | 17.1 | 0.24 | 119 | 1 | 51.14 |
| Cx 2 | PP4712 | / | 4 | 18.2 | 0.25 | 98 | 1 | 59.61 |
| Cx 3 | REXT2106 | / | 1 | 19.7 | 0.57 | 495 | 5 | 152.5 |
| Cx 4 | MDEX1033 | / | 1 | 14.3 | 0.12 | 276 | 5 | 161.2 |
| Cx 5 | Orevac18732 | / | 1 | 11.7 | 0.12 | 283 | 5 | 161.4 |
| Cx 6 | Orevac OE905 | / | 1 | 17.6 | 0.46 | 271 | 5 | 151.1 |
| Cx 7 | SM7-001 | / | 1 | 8.15 | 0.11 | 337 | 5 | 165.3 |
| Cx 8 | 50% SM7-001 | 50% AT1179 | 1 | 10.4 | 0.11 | 321 | 4 | 143.7 |
| Cx 9 | 50% SM7-001 | 50% PP4612 | 1 | 13.2 | 0.10 | 301 | 3 | 133.7 |
| Cx 10 | 50% SM7-001 | 50% PP4712 | 1 | 14.5 | 0.10 | 312 | 3 | 145.2 |

### Comparative Examples (Cx) 1 to 2

The metallizable skin layers of Comparative Examples 1 and 2 were respectively PP4612 and PP4712, which were not grafted. As shown in Table 3, the metallized films showed substantial metal pickoff, high OTR, high WVTR, and low bond strength, although the metallized skin layers retained good crazing resistance.

### Comparative Examples (Cx) 3 to 6

The metallizable skin layers of Comparative Examples 3 to 6 were respectively REXT2106, MDEX1033, Orevac™18732, and Orevac™ OE905. As shown in Table 3, the metallized films showed high OTR, high WVTR, substantial crazing, and substantial barrier degradation after extrusion lamination, although the metallized skin layers retained low metal pickoff and high bond strength.

### Comparative Examples (Cx) 7 to 10

The metallizable skin layers of Comparative Examples 7 to 10 were a grafted syndiotactic polypropylene homopolymer (sPP), SM7-001, and its blends with isotactic polypropylene homopolymers, respectively Admer® AT1179, PP4612, and PP4712. As shown in Table 3, the metallized films had substantial crazing and substantial barrier degradation after extrusion lamination, although the metallized skin layers retained low metal pickoff and high bond strength.

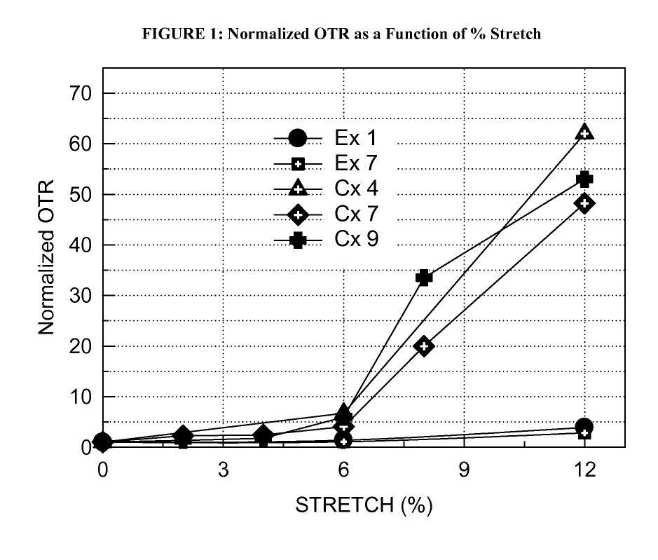

As demonstrated, the Example films showed unexpectedly, superior adhesive and barrier properties, i.e., no metal pickoff, low OTR, low WVTR, high bond strength, little or no metal crazing, and low OTR degradation after extrusion lamination. The barrier degradation properties of the films are further shown in FIG. 1, wherein the normalized OTR represents a ratio of OTR increases for selected samples of the laminated metallized films before and after 12% stretch. The Example films showed exceptionally low OTR increase, below 10 times at 12% stretch, while the Comparative Examples showed high OTR increase above 40 times.

Thus, while there have been described what are presently believed to be the preferred embodiments of the invention, those skilled in the art will realize that various changes and modifications may be made to the invention without departing from the spirit of such invention. All such changes and modifications which fall within the scope of the invention are therefore intended to be claimed.

1. A multilayer film comprising:
a. a metallizable skin layer comprising a polymer grafted by a graft monomer, said grafted polymer comprises at least one of a grafted isotactic polypropylene homopolymer, a grafted minirandom copolymer of isotactic polypropylene, a grafted propylene-based elastomer, or any combinations thereof; and
b. a metal layer deposited on said metallizable skin layer,
wherein the isotacticity of said isotactic polypropylene is 85% or greater; the ethylene concentration of said minirandom copolymer is 1.0 wt. % or lower; the propylene concentration of said propylene-based elastomer is 89 wt. % or greater; and, wherein said graft monomer comprises at least one of ethylenically unsaturated carboxylic acids, ethylenically unsaturated carboxylic acid derivatives and any combination thereof.

2. The multilayer film of claim 1, wherein the isotacticity of said isotactic polypropylene homopolymer is 90% or greater; the ethylene concentration of said minirandom copolymer is 0.5 wt. % or less; and the propylene concentration of said propylene-based elastomer is 91 wt. % or greater.

3. The multilayer film of claim 1, wherein the concentration of said grafted monomer is in the range from about 0.01 to about 5.0 wt. %.

4. The multilayer film of claim 1, wherein said propylene-based elastomer is ethylene propylene elastomer produced by metallocene catalysts.

5. The multilayer film of claim 1, wherein said metallizable skin layer has from about 1 to about 30 wt. % of said grafted propylene-based elastomer based on the total weight of said metallizable skin layer.

6. The multilayer film of claim 1, wherein graft monomer is maleic acid anhydride, glycidyl methacrylate, or combination thereof.

7. The multilayer film of claim 1, further comprising at least one of a core layer, a first tie layer, a second tie layer and a sealant layer.

8. The multilayer film of claim 7, wherein said core layer comprises less than 10 wt. % PLA.

9. The multilayer film of claim 1, wherein said film is oriented in at least one of MD or TD.

10. The multilayer film of claim 1, wherein said metal layer comprises at least one of aluminum, gold, silver, copper, and chromium.

11. A method of making multilayer film comprising:
a. extruding a composition to form a sheet, said composition comprising a polymer grafted by a graft monomer, said grafted polymer comprises at least one of a grafted isotactic polypropylene, a grafted minirandom copolymer of isotactic polypropylene, a grafted propylene-based elastomer, or any combinations thereof,
wherein the isotacticity of said isotactic polypropylene is 85% or greater; the ethylene concentration of said minirandom copolymer is 1.0 wt. % or lower; the propylene concentration of said propylene-based elastomer is 89 wt. % or greater; and, wherein said graft monomer comprises at least one of ethylenically unsaturated carboxylic acids, ethylenically unsaturated carboxylic acid derivatives and any combination thereof;
b. orienting said sheet in at least one of MD, TD, or both to form a film;
c. treating at least one exposed outer surface of said oriented film with corona, flame, plasma, or any combinations thereof; and
d. depositing a layer of metal on said treated surface of the metallizable skin layer of the oriented film.

12. The method of claim 11, wherein said extruding step is a co-extruding step comprising co-extruding additional composition(s).

13. The method of claim 11 wherein said graft monomer is maleic acid anhydride, glycidyl methacrylate, or combination thereof.

14. A film made by the method of claim 11.
